(19) United States
(12) Patent Application Publication
(10) Pub. No.: US 2008/0218825 A1
(43) Pub. Date: Sep. 11, 2008

(54) Optical Scanning Apparatus and Image Display Apparatus Using the Same

(76) Inventor: Tae-Sun Song, Gyeonggi-do (KR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 12/065,464

(22) PCT Filed: Aug. 9, 2006
(86) PCT No.: PCT/KR2006/003124

§ 371 Date: Feb. 29, 2008

(30) Foreign Application Priority Data
Aug. 29, 2005 (KR) 10-2005-0079155
Sep. 12, 2005 (KR) 10-2005-0084453
Oct. 4, 2005 (KR) 10-2005-0092711

(51) Int. Cl. G02B 26/08

(52) U.S. Cl. 359/199

(57) ABSTRACT

The optical scanning apparatus converts a rotational motion of a motor to a reciprocating linear motion such that light modulated by a light source is scanned in two dimensions. In addition, direction changers are formed on both ends of a route of the linear reciprocating motion of the light source so as to change the moving direction of the light source.

### BACKGROUND OF THE INVENTION

(a) Field of the Invention

The present invention relates to an optical scanning apparatus and an image display apparatus. More particularly, the present invention relates to an optical scanning apparatus using a linear light source undergoing a linear reciprocating motion or circulating in a shape of a polygon, and an image display apparatus using the same.

(b) Description of the Related Art

The invention relating to an optical scanning apparatus having a linear light source disposed on a circulating moving body is disclosed in Korean patent application number 10-2003-0071920 entitled “Two-dimensional optical scanning apparatus and image display apparatus using the same” under the name of the applicant of this application (Korean patent laid-open publication number 10-2005-0036288). In FIG. 7 and FIG. 8 of the aforementioned publication, the moving body includes at least two drums, and a belt or a chain connected to the drums. That is, it is configured such that the moving body circulates on the belt or the chain, but various optical scanning methods have been developed in addition to the circulating movement method.

### SUMMARY OF THE INVENTION

The present invention has been made in an effort to provide an optical scanning apparatus having an advantage of performing an optical scanning method for scanning light in two dimensions by linearly circulating a light source, and an image display apparatus using the same. The linear circulating motion includes a linear reciprocating motion and a circulating motion on a polygonal route.

In addition, the present invention has been made in an effort to provide an optical scanning apparatus in which the light source can undergo the linear reciprocating motion without using a drum and a belt.

An exemplary optical scanning apparatus according to an embodiment of the present invention includes a motor that rotates with respect to a rotation axis, a converting device that converts a rotational motion of the motor to a reciprocating linear motion, and a light source connected to the converting device so as to undergo a reciprocating linear motion and in which a plurality of light emitting elements emitting modulated light are arranged in order to transmit image information.

The converting device may includes a guider that limits a motion of the light source to a reciprocally moving motion, a first connector at least partially rotatably connected to the light source, and a second connector one end of which is rotatably connected to the first connector and the other end of which is fixedly connected to the motor.

An optical scanning apparatus according to another exemplary embodiment of the present invention includes a light source in which a plurality of light emitting elements that emit modulated light so as to transmit image information are arranged, a linear motor that moves the light source in a polygonal route or in a linear route, and a direction changer that changes a moving direction of the light source while the light source moves.

The direction changer may be configured to change a velocity or a direction of the light source by a collision. The direction changer may include a compensating body that collides with the light source so as to change the velocity or the direction of the light source, and may further include an elastic body connected to the compensating body so as to vibrate the compensating body in a specific cycle. In addition, the optical scanning apparatus may further include a sensor attached to the light source that detects velocity, displacement, or the like of the light source.

An optical scanning apparatus according to yet another exemplary embodiment of the present invention includes: a light source in which a plurality of light emitting elements that emit modulated light so as to transmit image information are arranged; an elastic body one end of which is connected to the light source and the other end of which is fixed, and that undergoes compression, expansion, or vibration so as to make the light source undergo a linear reciprocating motion; and a vibration controller that controls the compression, the expansion, or the vibration of the elastic body so as to control a velocity of the light source to be constant.

The vibration controller may include a permanent magnet disposed at one end of the elastic body and an electromagnet disposed at the other end of the elastic body, and wherein the compression, the expansion, or the vibration of the elastic body is controlled by controlling an electric current applied to the electromagnet. Alternatively, the vibration controller may include a plurality of electromagnets or magnets arranged on a route of a linear reciprocating motion of the light source so as to control a velocity of the light source.

### BRIEF DESCRIPTION OF THE DRAWINGS

FIG. 1 is a drawing showing an optical scanning apparatus according to a first exemplary embodiment of the present invention.

FIG. 2 is a drawing showing an optical scanning apparatus according to a second exemplary embodiment of the present invention.

FIG. 3 is drawing showing an exemplary variation of the optical scanning apparatus according to the second exemplary embodiment of the present invention.

FIG. 4 is a drawing showing an optical scanning apparatus according to a third exemplary embodiment of the present invention.

### DETAILED DESCRIPTION OF THE PREFERRED EMBODIMENTS

The present invention will be described more fully hereinafter with reference to the accompanying drawings, in which exemplary embodiments of the present invention are shown.

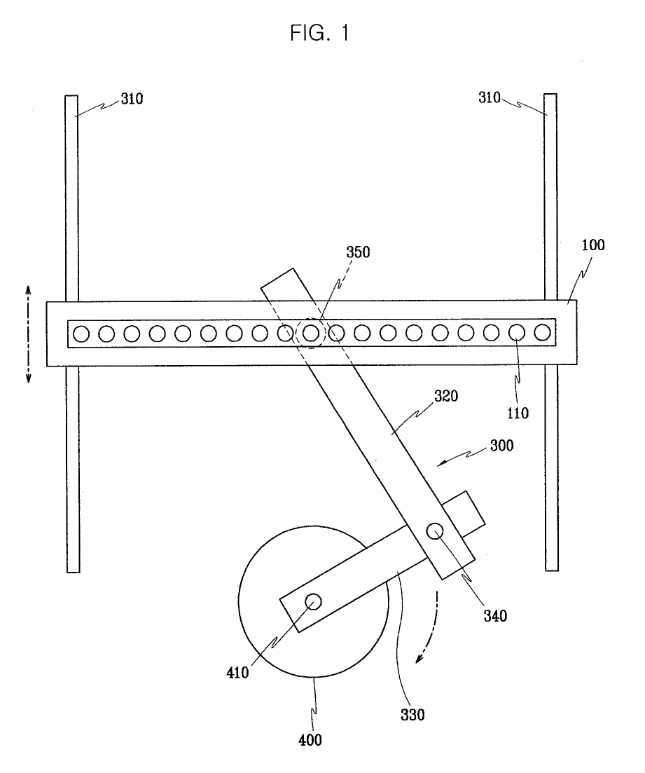

An optical scanning apparatus according to a first exemplary embodiment of the present invention will now be explained with reference to FIG. 1. The optical scanning apparatus shown in FIG. 1 includes a motor 400 that rotates with respect to a rotation axis 410, a converting device 300 that converts a rotating motion of the motor 400 to a reciprocating linear motion, and a light source 100 connected to the converting device 300 so as to undergo a reciprocating linear motion.

The motor 400 may be realized by a general rotating motor, and the invention can be variously realized by interposing gears between the motor and the converting device. In the case of transmitting the rotating force using gears and the like, positions of the motor and the converting device can be varied depending on design so that the space can be optimally used.

The light source 100 may preferably be realized by arranging a plurality of light emitting elements, e.g., laser diodes or light emitting diodes, in a line, and it emits modulated light of red color, green color, and blue color corresponding to an image that will be displayed. Image information may be delivered to the linear light source 100 through a wire connection or a wireless connection. As shown in FIG. 1, the light source 100 can be realized by a light source in which light emitting elements 110 are arranged in a single line, and if sufficient resolution cannot be obtained by the single line of light emitting elements or if the amount of light is not sufficient, the light source 100 can be realized by a light source in which light emitting elements are arranged in two or more lines. In addition, although one light source is shown in FIG. 1, a plurality of light sources can be provided under a relevant design.

The converting device 300 includes a guide rail 310 arranged so as to limit a motion of the light source 100 to a linear motion, a first connector 320 connected to the light source 100 so as to be at least partially rotatable and having a predetermined length, and a second connector 330 one end of which is rotatably connected to the first connector and the other end of which is fixedly connected to the rotation axis 410 of the motor 400 and having a predetermined length. The guide rail 310 may be formed with various shapes, e.g., as a rod having a section shape of a quadrangle or a circle, as a pin, or as a pipe, and it is sufficient that the guide rail 310 can limit the motion of the second connector to a linear motion. The first connector 320 and the second connector 330 are rotatably connected to one another by a coupling axis 340, and may use a bearing, a roller, etc. In addition, in order to enhance the stability of the operation, another connector can be added between the first and second connectors, or a plurality of parts can be added. The first connector 320 and the light source 100 are rotatably connected to one another by a coupling axis 350.

Operations of the two-dimensional optical scanning apparatus according to the first exemplary embodiment of the present invention are as follows.

If the motor 400 is rotated by being applied with electric power from an electric power source (not shown), the second connector 330 fixedly connected to the motor 400 rotates with respect to the rotation axis 410. One end of the first connector 320 is connected to the second connector 330 so as to rotate with respect to the coupling axis 340, and the other end thereof is connected to the light source 100 so as to rotate with respect to the coupling axis 350. Accordingly, an end portion of the first connector 320 near the coupling axis 340 undergoes a rotational motion, and motion of an end portion of the first connector 320 near the coupling axis 350 is limited to a direction of the guide rail 310. That is, the light source 100 is connected to the first connector 320 with respect to the coupling axis 350, and the motion thereof is limited to a direction of the guide rail, which is perpendicular to the rotation axis 410 of the motor 400, by the guide rail 310, so that the light source 100 undergoes a reciprocating linear motion along the guide rail 310. Accordingly, the rotational motion of the motor 400 is converted to the reciprocating linear motion of the light source 100 by the combination of the first connector 320 and the second connector 330 that are connected to one another to be rotatable relative to one another.

In more detail, the second connector 330 rotates to draw a circle with a radius corresponding to a distance to the coupling axis 340 with respect to the rotation axis 410, and the first connector 320, which is rotatably connected to the second connector 330 with respect to the coupling axis 340, is rotatably connected to the light source 100 with respect to the coupling axis 350. If the second connector 330 rotates to draw a circle, force and torque act on the light source since the first connector 320 has a predetermined length, and since the light source can be moved only in a specific linear direction by the guide rail 310, the light source linearly moves along the guide rail. That is, if the second connector 330 undergoes one revolution, the light source 100 undergoes one reciprocating linear motion. Since the one reciprocating linear motion of the light source 100 reciprocally moves in the same section, two scans can be made by the one reciprocating linear motion of the light source 100, and the light source 100 can successively undergoes the reciprocating linear motion in the same section by the successive rotational motions of the second connector 330, so that the scanning corresponding to two revolutions of the motor can be performed along the linear guide rail.

Meanwhile, while not shown in the drawing, torque may act on the rotation axis 410 by the weight of the light source 100 and the first connector 320, and this may cause noise and vibration. Accordingly, in order to offset this torque, a body having suitable weight, e.g., a weight can be coupled to an end portion of the second connector 330 near the rotation axis 410 so as to cancel torque acting on both sides thereof, thereby enhancing mechanical stability. In addition, the torque can also be offset by coupling another connector to an end portion of the second connector 330 near the rotation axis 410 that operates in the same manner in an opposite direction to the first connector 320, and this can be realized by relevant designs.

A linear motion range of the light source 100 becomes longest when a center line in a moving direction of the light source 100 passes a center of the motor 400. In this case, when a distance between two coupling axes 340 and 350 of the first connector 320 is referred to as an effective length of the first connector and a distance between the two axes 410 and 340 of the second connecting part is referred to as an effective length of the second connector, a range of a display screen in a scanning direction corresponds to a difference between the effective length of the first connector and the effective length of the second connector to a sum of the effective length of the first connector and the effective length of the second connector. Accordingly, the length of the region of the display screen in the scanning direction becomes twice the effective length of the first connector.

The light source 100 emits light that is modulated according to a control signal input thereto and scans the same while undergoing the reciprocating linear motion. At this time, it is preferable that the linear velocity of the linear motion of the light source 100 is maintained to be constant. However, since the linear velocity of the reciprocating linear motion is not constant when the motor operates at a constant rotating velocity, a sensor may be installed to the light source 100 and the linear velocity can be compensated. That is, the linear velocity of the light source 100 can be maintained to be constant by checking a position of the light source 100 and controlling light modulation at the corresponding position, or by controlling the rotational velocity of the motor 400.

In addition to the method described above for maintaining the linear velocity of the light source to be constant, a mechanical method for adopting an additional connector between the first connector and the second connector can be used. Such a mechanical method is well known in the field of design of machinery, and a connector, a coupling axis, and other mechanisms can be added between the first connector and the second connector so as to maintain the moving velocity of the light source to be constant (referring to “Robert L. Norton, Design of Machinery, McGraw-Hill”).

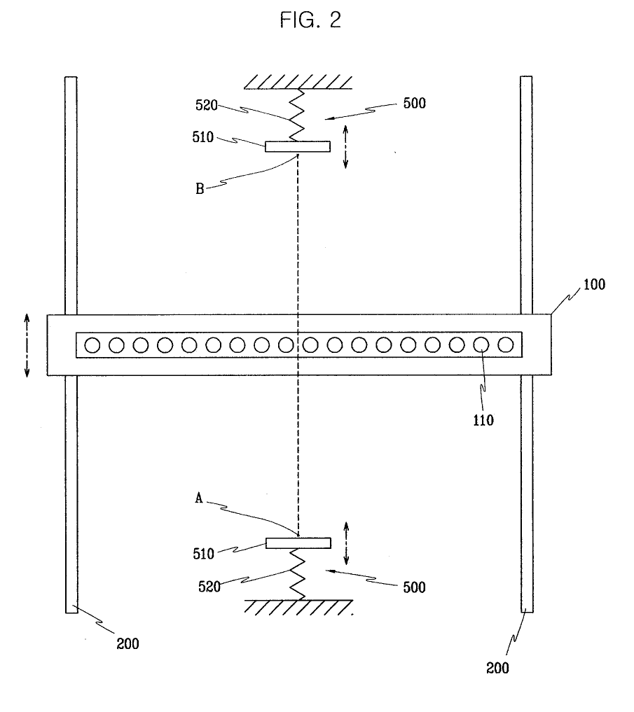

An optical scanning apparatus according to a second exemplary embodiment of the present invention will be explained hereinafter with reference to FIG. 2. The optical scanning apparatus shown in FIG. 2 includes a linear motor 200, a light source 100 connected to the linear motor 200 so as to undergo a linear reciprocating motion and including a plurality of light emitting elements arranged in a length direction thereof, and two direction changers 500 respectively disposed on both ends of the moving route of the light source 100 and changing the moving direction of the light source 100.

The light source 100 is similar to the light source of the optical scanning apparatus according to the first exemplary embodiment of the present invention.

The light source 100 is attached to the linear motor 200 so as to undergo a linear motion. The linear motor 200 is generally operated by an electromagnetic force, and it can be realized in various ways. For example, the linear motor 200 can be realized with permanent magnets arranged along the moving direction and an electromagnet that moves on the permanent magnets. If poles of the electromagnet are altered in a constant cycle by the control of electric current, an attraction force and a repulsive force are suitably generated in response to the N (north) pole and the S (south) pole of the permanent magnets arranged along the moving direction, so that the linear motion can be made.

Although such linear motor is used, great energy is temporarily needed in order for the light source 100 to change the moving direction at the point A or B shown in FIG. 2 while moving the specific range. That is, since the velocity of the light source should be suddenly changed in order to change the moving direction at the point A or B, much more energy than normally required in the liner motion range is temporarily needed, and it is difficult to maintain a constant velocity after the moving direction is changed.

In the second exemplary embodiment of the present invention, the moving direction of the light source is changed using kinetic energy of the direction changer 500 and the light source 100 so that the velocity of the light source 100 can be maintained to be constant in the linear range.

The direction changer 500 includes a compensating body 510 that collides with the light source 100 so as to change the velocity of the light source 100, and an elastic body 520 connected to the compensating body 510 so as to vibrate the compensating body 510 in a constant cycle. The elastic body 520 may be formed as a spring for vibrating the compensating body 510.

Operations of the two-dimensional optical scanning apparatus according to the second exemplary embodiment of the present invention are as follows.

If the linear motor 200 is applied with electric power from an electric power source (not shown), the light source 100 undergoes the linear motion by the linear motor 200. For example, in the case that the light source 100 moves linearly downward toward the point A, the linear motor 200 is operated until it advances to within a predetermined distance to the point A such that the light source 100 moves at a constant linear velocity, and even through the supply of the electric power to the linear motor is instantly cut off, the light source 100 can move at the constant velocity and collide with the compensating body 510 at the point of A. At this time, the compensating body 510 undergoes the vibrating motion in a specific cycle by the elastic body 520, and in this case, if the compensating body 510 moves in a direction opposite to the moving direction of the light source 100, the light source 100 collides with the compensating body 510 so that the light source 100 moves upwardly toward the point B. Electric power is again applied to the linear motor 200 simultaneously with the moving of the light source 100 toward the point B, so that it is controlled that the light source 100 undergoes the linear motion at the constant linear velocity. While the light source 100 moves at the constant linear velocity, the operation of the linear motor 200 is stopped when the light source 100 advances to within a predetermined distance to the point B, and the light source 100 collides with the upper compensating body 510 at the point B so that the moving direction thereof is changed. In this manner, the light source 100 reciprocally moves between the points A and B. Accordingly, the moving direction of the light source 100 changes with every collision with the compensating body 510, and this indicates a new scan, so the number of collisions in a unit period is equal to the number of screen scans for a unit period.

After the collision with the light source 100, the vibrating characteristic of the compensating body 510 is changed by the collision, in this case by controlling the compensating body 510 and the elastic body 520, and the vibrating state of the compensating body 510 can be changed to have a desired cycle and a desired position until the next collision. In order to check the velocity and the phase of the direction changer and to control the same, it is preferable to install a sensor to the direction changer or to receive signals of an outer sensor.

At this time, in order to increase the velocity change of the light source 100, it is preferable that the mass of the compensating body 510 is greater than that of the light source 100, and although it is described above that the compensating body vibrates in a constant cycle, it is also possible that the compensating body does not vibrate.

The light source 100 emits light modulated according to control signals input thereto and scans the same while undergoing the linear reciprocating motion.

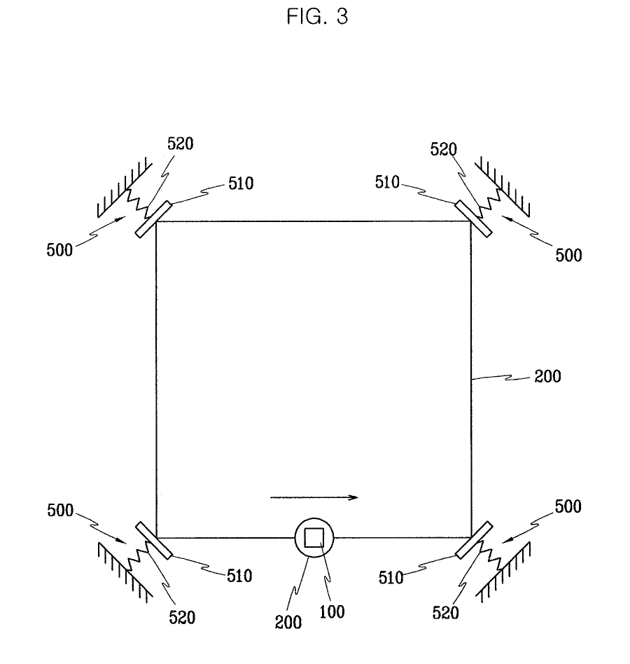

Although it is described above that the light source undergoes the linear reciprocating motion, the optical scanning apparatus according to the second exemplary embodiment of the present invention can also be applied to the case in which the light source circulates or reciprocates in a polygonal route. FIG. 3 exemplarily shows the case in which the light source scans while circulating in a quadrangle route. That is, in the case that the moving route of the light source 100 is a quadrangle, direction changing devices 500 are respectively provided at apexes of the quadrangle such that the moving direction of the light source 100 can be at a right angle to its previous moving direction by the direction changing device 500. The light source 100 may be disposed on a supporting member such that a length direction thereof is horizontal, so as to scan light to the outside of the quadrangle.

Although FIG. 2 and FIG. 3 show the case in which the light source and the compensating body mechanically collide with one another, the case in which the light source and the compensating body magnetically or electrically collide with one another can also be applied.

Further, in addition to adopting the linear motor as shown in FIG. 2 and FIG. 3, a case in which a motor with an axis that is configured to undergo a linear motion is adopted or a case in which a method for converting the rotational motion of a motor to a linear motion is used can also be similarly applied.

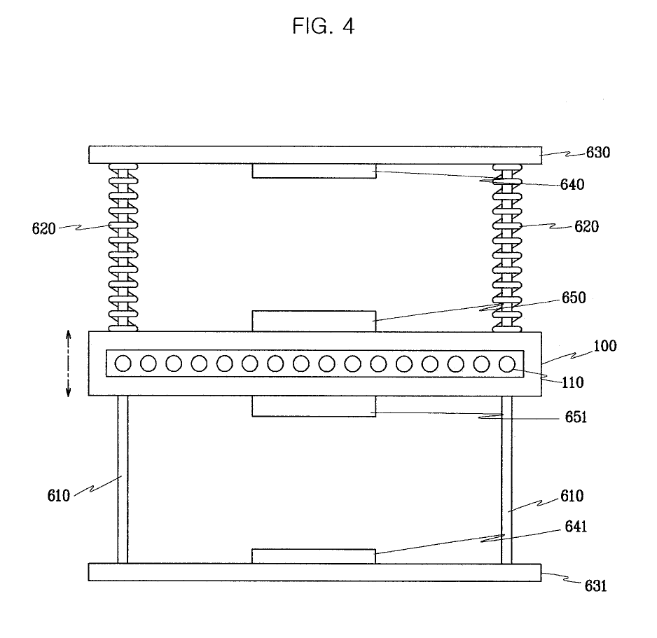

An optical scanning apparatus according to a third exemplary embodiment of the present invention will be explained hereinafter with reference to FIG. 4. The optical scanning apparatus according to the third exemplary embodiment of the present invention uses mechanical power, i.e., compression and expansion of an elastic body such as a spring, as a power for endowing the linear reciprocating motion to the light source.

The optical scanning apparatus shown in FIG. 4 includes a light source 100 including a plurality of light emitting elements arranged along a length direction thereof, fixing members 630 and 631 formed at both ends of the moving route of the light source, a guide rod 610 both ends of which are respectively connected to the fixing members 630 and 631 so as to define the moving route of the light source 100, a spring 620 elastically connected to the light source 100 and the fixing member 630, electromagnets 640 and 641 respectively attached to the fixing members 630 and 631 so as to control the compression and the expansion or the vibrating motion of the spring 620, and permanent magnets 650 and 651 attached to the light source. At this time, the electromagnets 640 and 641 and the permanent magnets 650 and 651 form a vibration controller that performs a function of controlling the vibration of the spring.

The light source 100 is similar to the light source of the optical scanning apparatus according to the first exemplary embodiment of the present invention.

The spring 620 repeats the compression and the expansion in the moving route of the light source 100, thereby making the light source 100 undergo the linear reciprocating motion. At this time, although the fixing member and the guide rod are exemplarily shown as members for forming the moving route of the light source 100 in FIG. 4, the guide rod can be substituted by a rail, etc., and the rail can form the moving route of the light source together with a bearing, an air bearing, a roller, etc.

In the case that the linear reciprocating motion of the light source is obtained only by the spring, the vibration may be dampened by friction so that the velocity of the light source can be decreased, so the permanent magnets 650 and 651 and the electromagnets 640 and 641 are used as the vibration controller so as to offset the friction. That is, when the light source 100 moves toward the fixing member 630, electrical current applied to the electromagnet 640 is controlled such that attraction force is generated between the electromagnet 640 and the permanent magnet 650, and when the light source 100 moves in an opposite direction, electrical current applied to the electromagnet 640 is controlled such that a repulsive force is generated between the electromagnet 640 and the permanent magnet 650. In the case that the light source 100 moves toward the fixing member 631, control of electric current applied to the electromagnet 631 can be similarly performed.

Although FIG. 4 shows that the permanent magnet is attached to the light source and the electromagnet is attached to the fixing member, it may be possible that the electromagnet is attached to the light source and the permanent magnet is attached to the fixing member. In addition, a plurality of permanent magnets and electromagnets may be provided to the fixing member and the light source according to design, and a plurality of the guide rods and the springs may also be provided.

In addition, although FIG. 4 shows that the electromagnet is attached to the fixing member as the vibration controller, like the structure of the conventional linear motor, the velocity of the light source can be precisely controlled by arranging a plurality of electromagnets (or permanent magnets) on the moving route of the light source such that the north pole and the south pole thereof are alternately arranged, and precisely controlling attraction/repulsive force between the permanent magnets (or electromagnets) attached to the light source.

Meanwhile, while not shown in the drawings, a magnifying lens may be installed in front of the light source so as to magnify the size of a scanned screen, and an optical error can be compensated using a relative compensation lens so as to improve the quality of images.

Furthermore, although it is described above that the optical scanning apparatus according to the first to third embodiments of the present invention include one light source, it is also possible that a plurality of light sources can be provided. In addition, if necessary, the light source can be formed as a ring shape or a band shape in addition to the linear shape.

Furthermore, in the second exemplary embodiment of the present described with reference to FIG. 3, a plurality of light sources may be provided, and a separate display screen can be formed for respective light sources, thereby having an advantage of being able to scan various images.

The guide rail of the first embodiment may be used in the second embodiment or the third embodiment in order to guide the linear motion. The guide rail can be realized by a mechanism of a pin shape and a ball bearing, or by a rod, a pipe, or various hollow shafts together with a bearing, a bushing, or a roller. In addition, so as to reduce noise due to contact between mechanical parts, an air bearing, an air bushing, or a magnetic bearing may be used.

Although it is described above that the embodiments of the present invention are independent from each other, the embodiments can be realized in one optical scanning apparatus. For example, the rotational motion of the rotating motor may be converted to the linear motion of the light source, and at the same time, the reciprocal motion by the spring in the third embodiment can be annexed thereto.

As described above, in the optical scanning apparatus according to the present invention, various scanning methods can be performed by moving the rotating motor or the circulating light source.

In addition, although only the optical scanning apparatus is described in this specification, an image display apparatus can be realized by disposing a screen on an image display scanned by the light source.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical scanning apparatus, comprising:
a motor that rotates with respect to a rotation axis;
a converting device that converts a rotational motion of the motor to a reciprocating linear motion; and
a light source connected to the converting device so as to undergo a reciprocating linear motion, and in which a plurality of light emitting elements emit modulated light in order to transmit image information are arranged.

2. The optical scanning apparatus of claim 1, wherein the converting device comprises:
a guider that limits a motion of the light source to a reciprocally moving motion;
a first connector at least partially rotatably connected to the light source; and
a second connector, one end of which is rotatably connected to the first connector and the other end of which is fixedly connected to the motor.

3. The optical scanning apparatus of claim 1, wherein an axis direction of the motor and a moving direction of the light source are perpendicular to one another.

4. The optical scanning apparatus of claim 1, further comprising a sensor attached to the light source and detecting velocity, displacement, or the like of the light source.

5. An optical scanning apparatus, comprising:
a light source in which a plurality of light emitting elements that emit modulated light so as to transmit image information are arranged;
a linear motor that moves the light source in a polygonal route or in a linear route; and
a direction changer that changes a moving direction of the light source while the light source moves.

6. The optical scanning apparatus of claim 5, wherein the direction changer changes the velocity or direction of the light source by a collision.

7. The optical scanning apparatus of claim 5, wherein the direction changer comprises a compensating body that collides with the light source so as to change the velocity or direction of the light source.

8. The optical scanning apparatus of claim 7, wherein the direction changer further comprises an elastic body connected to the compensating body so as to vibrate the compensating body in a specific cycle.

9. The optical scanning apparatus of claim 7, wherein directions of the velocities of the light source and the compensating body are different from one another.

10. The optical scanning apparatus of claim 5, wherein a moving direction of the light source and a length direction of the light source are perpendicular to one another.

11. The optical scanning apparatus of claim 5, further comprising a sensor attached to the light source and detecting velocity, displacement, or the like of the light source.

12. The optical scanning apparatus of claim 7, which is configured such that the number of collisions and the number of scanned images are equal to each other.

13. An optical scanning apparatus, comprising:
a light source in which a plurality of light emitting elements that emit modulated light so as to transmit image information are arranged;
an elastic body, one end of which is connected to the light source and the other end of which is fixed, and that undergoes compression, expansion, or vibration so as to make the light source undergo a linear reciprocating motion; and
a vibration controller that controls the compression, the expansion, or the vibration of the elastic body so as to control a velocity of the light source to be constant.

14. The optical scanning apparatus of claim 13, wherein the vibration controller comprises a permanent magnet disposed at one end of the elastic body and an electromagnet disposed at the other end of the elastic body, and wherein the compression, the expansion, or the vibration of the elastic body is controlled by controlling electric current applied to the electromagnet.

15. The optical scanning apparatus of claim 13, wherein the vibration controller comprises a plurality of electromagnets or magnets arranged on a route of linear reciprocating motion of the light source so as to control the velocity of the light source.
